(19) United States
(12) Patent Application Publication
(10) Pub. No.: US 2016/0069085 A1
(43) Pub. Date: Mar. 10, 2016

(54) Floor Covering

(71) Applicant: TARKETT GDL, Lentzweiler (LU)

(72) Inventors: Jean-Yves Simon, Chiny (BE); Agnés Parmentier, Wiltz (LU); Michel Cancellier, Wiltz (LU); Benjamin Cornez, Wiltz (LU)

(21) Appl. No.: 14/783,998

(22) PCT Filed: Apr. 9, 2014
(86) PCT No.: PCT/EP2014/057164

§ 371 Date: Oct. 12, 2015

(30) Foreign Application Priority Data
Apr. 12, 2013 (EP) 13163465.1

(51) Int. Cl. E04F 15/02; B32B 27/30; B32B 3/06; E04F 15/10; E04F 15/16

(52) U.S. Cl. CPC E04F 15/02038; E04F 15/10; E04F 15/16; B32B 3/06; B32B 27/304; B32B 2419/04

(57) ABSTRACT

The present invention relates to a resilient polymer-based surface covering element (1) in the form of a strip having a length-to-width ratio of eight or more, said polymer-based surface covering element (1) comprising an upper surface (2), a lower surface (3), side edges (4, 5, 6, 7) provided between said upper surface (2) and said lower surface (3), and connection means (8) to join two or more surface covering elements (1).

### SUBJECT OF THE INVENTION

The present invention relates to a resilient polymer-based surface covering element in the form of a long strip comprising connecting means and relates to a polymer-based surface covering comprising such element.

### PRIOR ART

Polymer-based surface coverings, also called polymeric or synthetic surface coverings are well known. Generally they are made of rubber, polyolefins, polyesters, polyamides or PVC. They present specific mechanical properties, particularly in terms of mechanical resistance, wear and indentation resistance, but also in terms of comfort, softness, sound and heat insulation.

Among polymer-based surface coverings, substrate-free surface coverings and multilayer surface coverings are also well known.

Substrate-free surface coverings, or homogenous surface coverings, are coverings comprising agglomerated particles, generally obtained by cutting or shredding a sheet made from a composition which comprises a polymer-based material and wherein no bottom layer, or substrate, is used.

Multilayer surface coverings are coverings comprising at least a lower layer being a support layer and an upper layer being a wear layer. Furthermore, these coverings are referred to be decorative as they generally comprise a decorative pattern imitating the aesthetic appearance of natural floorings such as wood or stone floorings. This decorative pattern is generally printed on one of the faces of the support layer or the wear layer of the floor covering, or sometimes on an additional synthetic layer which is inserted between the support layer and the wear layer.

Polymer-based surface coverings, in particular floor coverings, are generally in the form of a single roll of a wide length and a wide width to be installed in one piece, or in the form of surface covering elements, or tiles, to be laid adjacent one to another on the surface to cover.

However, WO 2010/094597 discloses synthetic floor coverings in the form of a strip having a width corresponding to the width of a natural floor covering element to be imitated and a length corresponding to the length of at least two natural floor covering elements to be imitated.

Whatever the form of the polymer-based surface coverings, the surface covering or surface covering elements are laid on the floor using adhesive means, generally a glue, which have the drawback of being not easy to use, in particular if the glue is spread on the surface (floor for example) to cover before the surface covering or surface covering elements are laid.

The glue may be provided on the face of the surface covering entering into contact with the surface to cover, thus a protective sheet or paper should be remove before the surface covering or surface covering elements can be laid on the surface to cover. However, this solution presents the drawback of needing a supplementary manipulation.

Therefore there is a need for polymer-based surface covering elements in the form of strips easy to manipulate and to use.

### AIMS OF THE INVENTION

The present invention provides a solution that does not present the drawbacks of the prior art.

It provides an polymer-based surface covering element easy to install and a polymer-based surface covering being dimensional stable without the use of a glue.

### SUMMARY OF THE INVENTION

The present invention describes a resilient polymer-based surface covering element in the form of a strip having a length-to-width ratio of eight or more, said polymer-based surface covering element comprising an upper surface, a lower surface, side edges provided between said upper surface and said lower surface, and connection means to join two or more surface covering elements. The connection means preferably comprise connection profiles.

According to particular embodiments, the resilient polymer-based surface covering element comprises one or a suitable combination of any of the following characteristics:
the connection means are provided on one or more edges of the surface covering element,
the connection means are provided on two opposite and/or adjacent edges of the surface covering element,
the connection means comprise at least a male or female portion (or profile), the male portion extending outwardly from one or more edges of the surface covering element, the female portion extending inwardly from one or more edges of the surface covering element,
the male or female portion of the connection means comprises adhesive means,
the connection means comprises a male portion extending outwardly from one or more edges and a female portion extending inwardly from one or more edges, the male and female portions being complementary to, and for cooperation with, respectively the female and male portions of another surface covering element,
the connection means are provided along the entire length and/or width of said surface covering element,
the connection means form a tongue and groove engagement,
the connection means form puzzle type of engagement,
the surface covering element is made of PVC, polyolefin, reticulated and non-reticulated elastomer,
the surface covering element is a multilayer covering comprising a support layer and a wear layer,
the length-to-width ratio is comprised between 8 and 300.

According to a particularly preferred aspect of the invention, the resilient polymer-based surface covering element is configured as a roll, e.g. a flooring roll, to be laid out by unrolling from the roll. The surface covering element is in this case wound up (on a cylindrical core or without any core) in the direction of its long edge, the short edges being parallel to the axis of the roll. In the case of a flooring roll, a male portion of the connection means is preferably provided on one long edge of the surface covering element and a female portion of the connection means is preferably provided on the other long edge of the surface covering element, the male and female portions preferably being mutually complementary. The width of the flooring roll, i.e. the width of the wound up surface covering element preferably amounts to between 6 cm and 40 cm, more preferably between 10 cm and 30 cm. The length preferably ranges from 5 m to 30 m.

The present invention further relates to a polymer-based surface covering comprising at least one resilient polymer-based surface covering elements according to the invention.

### BRIEF DESCRIPTION OF FIGURES

FIG. 1 is a schematic representation of an upper view of a surface covering element according to the invention imitating a wood covering.

FIG. 2 is a first schematic representation of a transversal view of a first embodiment of the surface covering according to the invention.

FIG. 3 is a second schematic representation of a transversal view of a first embodiment of the surface covering according to the invention.

FIG. 4 is a third schematic representation of a transversal view of a first embodiment of the surface covering according to the invention.

FIG. 5 is a first schematic representation of a transversal view of a second embodiment of the surface covering according to the invention.

FIG. 6 is a second schematic representation of a transversal view of a second embodiment of the surface covering according to the invention.

FIG. 7 is a third schematic representation of a transversal view of a second embodiment of the surface covering according to the invention.

FIG. 8 is a first schematic representation of a transversal view of a third embodiment of the surface covering according to the invention.

FIG. 9 is a second schematic representation of a transversal view of a third embodiment of the surface covering according to the invention.

FIG. 10 is a third schematic representation of a transversal view of a third embodiment of the surface covering according to the invention.

FIG. 11 a schematic representation of an upper view of a plurality of surface covering elements imitating a wood covering being connected together.

FIG. 12 a schematic representation of a transversal view of a plurality of surface covering elements of the third embodiment being connected together.

FIG. 13 a schematic representation of a flooring roll according to a preferred aspect of the invention.

### DETAILED DESCRIPTION OF THE INVENTION

The polymer-based surface covering element 1 according to the invention is a resilient polymer-based element 1. Preferably, it fulfills the recommendation of the norm ISO 10581.

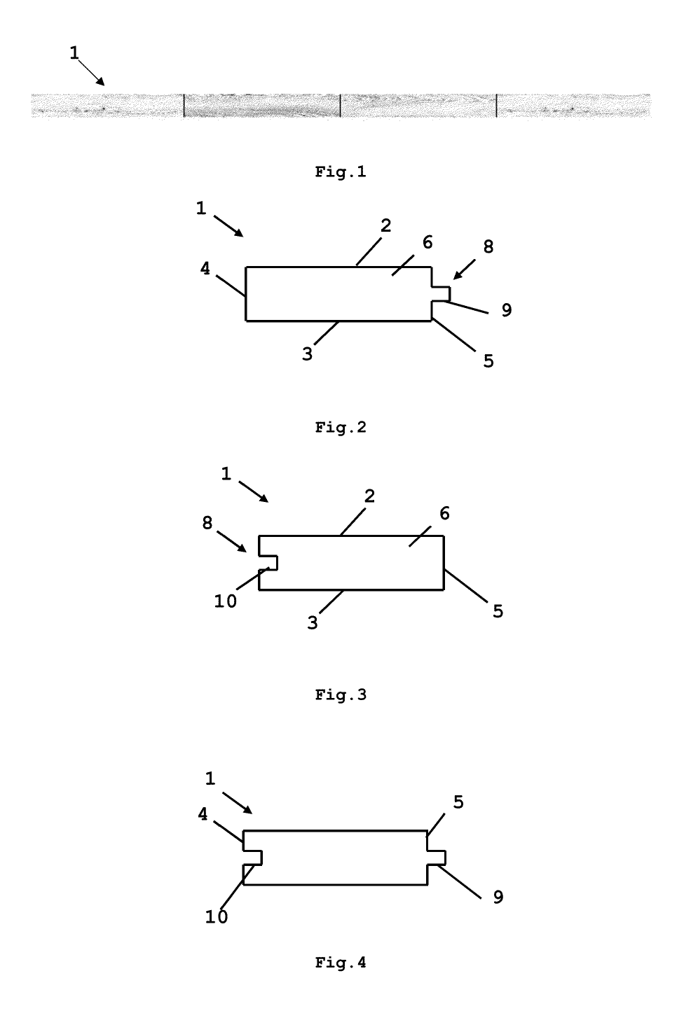

The polymer-based surface covering element 1 is in the form of a strip having a length higher than its width (FIG. 1), preferably its length is more than twice its width, i.e. the length-to-width ratio being equal or more than 8. Preferably, the length-to-width ratio is comprised between 8 and 300, more preferably between 8 and 40, 20 to 150, or 60 to 300, even more preferably between 80 and 120.

For example, the width of the polymer-based surface covering element 1 may be comprised between 10 cm to 50 cm, preferably between 10 to 20 cm for a length comprised between 400 cm to 3000 cm.

A polymer-based surface covering element 1 in the form of a strip has the advantage of allowing surface covering elements to be packed in small rolls easy to handle, to transport, to store and to lay out, especially by a single individual.

The polymer-based surface covering element 1 according to the invention comprises an upper surface 2, a lower surface 3 opposed to the upper surface 2, and four edges 4, 5, 6, 7, said edges being provided between the upper surface 2 and the lower surface 3 (FIGS. 2 to 10).

The polymer-based surface covering element 1 comprises connection means 8 to couple, or join, together a first surface covering elements 1 with at least a second, preferably a plurality of, surface covering elements 1.

The connection means 8 may be provided, continuously or discontinuously, on the upper surface 2 and/or lower surface 3 of the surface covering element 1, and/or on one edge or a plurality of edges 4, 5, 6, 7 of the surface covering element 1, or a combination thereof.

Preferably, the connection means 8 are provided on one edge (4 or 5 or 6 or 7), on two opposite edges (4 and 5 or 6 and 7), on adjacent edges (4 and 6, 4 and 7, 5 and 6, 5 and 7), on adjacent and opposite edges (4-5-6, or 4-5-7, or 4-6-7, or 5-6-7) or on all the edges (4, 5, 6, 7) of the surface covering elements 1.

In a preferred embodiment, the connection means 8 comprise a male portion complementary to and for cooperation with a female potion of another surface covering element 1, the male portion extending outwardly from one edge or a plurality of adjacent or opposite edges (figures and 5). Preferably, the male portion extends along a portion or the entire length and/or width of the surface covering elements 1.

In another preferred embodiment, the connection means 8 comprise a female portion complementary to and for cooperation with a male potion of another surface covering element 1 (FIGS. 3 and 6). Preferably, the female portion extends inwardly from one edge or a plurality of adjacent or opposite edges. Preferably, the female portion extends along a portion or the entire length and/or width of the surface covering elements 1.

In an additional preferred embodiment, the connection means comprise a male portion extending outwardly from one edge or a plurality of adjacent or opposite edges and a female portion extending inwardly from one edge or a plurality of adjacent or opposite edges (FIGS. 4 and 7), the male and female portions, being complementary to and for cooperation with respectively the female and male potions of another surface covering element 1. Preferably, the male and female portions extend along a portion or the entire length and/or width of the surface covering elements 1.

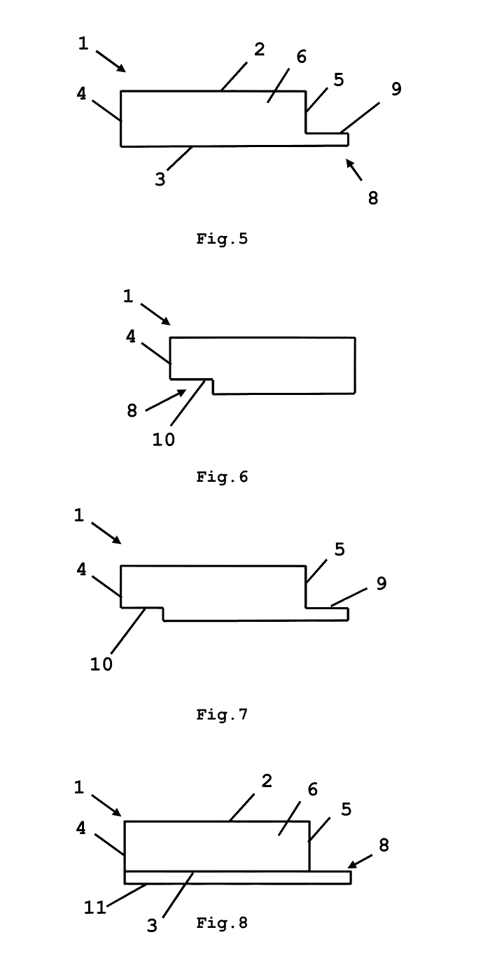

Preferably, the male portion is a tongue and the female portion is a groove extending from the middle of the edge or edges (FIGS. 2 to 4), extending from the lower portion of the edges or edges (FIGS. 5 to 7) or extending from the upper portion of the edges or edges (not shown).

Preferably, the connection means 8 form a puzzle type engagement.

In a another preferred embodiment, the surface covering element 1 comprise a layer 11 connected by any suitable means to the lower surface 3 of said surface covering element 1. The connection means 8 may thus comprise a male portion made by the layer 11 extending outwardly from, and under, one edge or a plurality of adjacent or opposite edges of the surface covering element 1 (FIG. 8). The male portion may comprise, or not, adhesive means, for example a glue, to allow connecting another surface covering element 1, which may comprise, or not, connection means 8 complementary and for cooperation with the male portion of said layer 11.

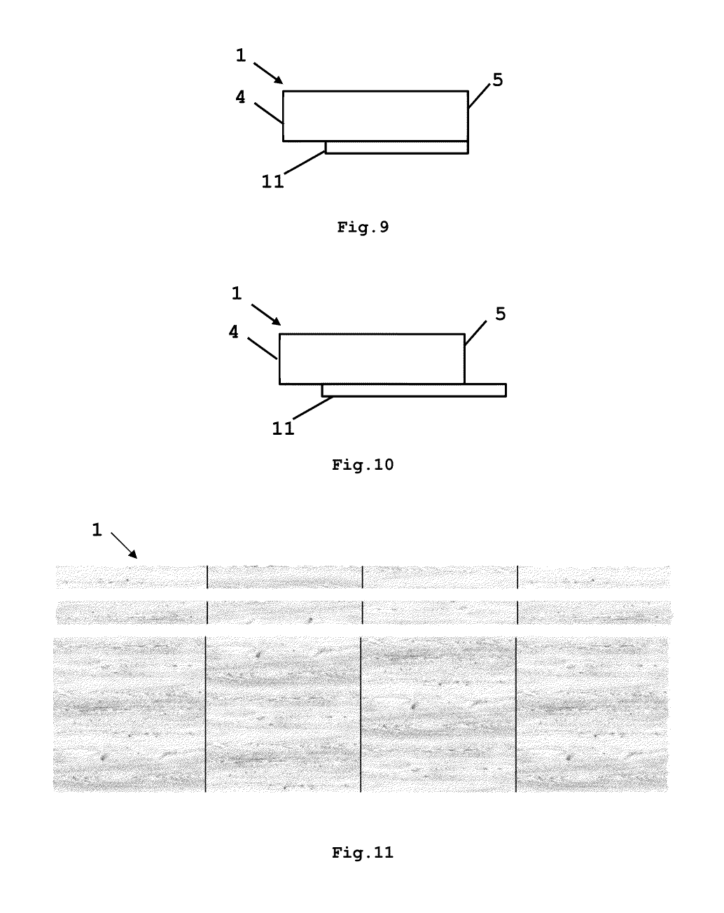

In this embodiment, the surface covering element 1 may comprise a female portion made by the layer 11 extending inwardly from, and under, one edge or a plurality of adjacent or opposite edges of the surface covering element (FIG. 9). The female portion may comprise, or not, adhesive means, for example a glue, to allow connecting another surface covering element 1 which may comprise or not connection means 8 complementary and for cooperation with the female portion of the layer 11.

In this embodiment, the surface covering element 1 may comprise a male portion made by the layer 11 extending outwardly from, and under, one edge or a plurality of adjacent or opposite edges of the surface covering element and a female portion made by the layer 11 extending inwardly from, and under, one edge or a plurality of adjacent or opposite edges of the surface covering element 1 (FIG. 10). The male and/or female portions may comprise adhesive means, for example a glue, to allow connecting another surface covering element 1, which may comprise, or not, connection means 8 complementary and for cooperation with the female and or male portion of said layer 11.

The connection means 8 may be produce by cutting, laser or water jet cutting, milling, drilling, moulding, planning the surface covering element 1 or by adding a layer 11 to a previously manufactured surface covering element 1 or during the manufacturing of the surface covering element 1.

The polymer-based floor covering element 1 is made of a polymeric material or a thermoplastic resin. Preferably, it is made of rubber, polyvinyl chloride, reticulated and non-reticulated elastomers, polyesters, poly-olefins, such as for example polypropylene or polyethylene, vulcanised resins, such as SBS (Styrene butadiene Styrene) for example, or cross-linked resins such as SBR (Styrene Butadiene Rubber) for example.

Preferably, the polymer-based floor covering element 1 is made of polyvinyl chloride.

The polymer-based floor covering element 1 may be an homogenous (substrate-free) or multiple layer surface covering element. Preferably, it is a product listed according to European standard EN 651, polyolefin-based floor covering element such as described in patent EP 1567336, polyvinyl chloride-based floor covering element according to standard EN 653, or expanded polyvinyl chloride-based floor coverings according to standard EN 649. Advantageously, it may be a floor covering element described in patent applications EP 1276621 and EP 1639193, or in patents EP 1360366 and EP 1507920.

Preferably, the polymer-based surface covering element 1 comprises a decorative pattern that imitates elements of natural surface coverings joined together one after the others. Therefore, the polymer-based surface covering element 1 is strip having a width corresponding to the width of a natural surface covering element to be imitated, namely to the width of a wooden slat, a stone or a floor tile for example and a length corresponding to the length of at least two natural surface covering elements to be imitated joined together. Considering that a decorative module reproduces, in terms of aesthetics and dimensions, an element of natural surface covering (wooden slat, a stone, a floor tile for example), the surface covering element 1 may thus comprise at least two, preferably a plurality, of such decorative modules, one after the other, separated by a pattern reproducing a joint connecting the elements of natural surface covering to be imitated.

Preferably, the length of the decorative modules is a function of the natural surface covering elements to be imitated. Their length is modulated by the frequency of the appearance of the pattern imitating the joint in the natural pattern of the surface covering according element 1. For example, for surface covering element 1 imitating a wooden slat, the pattern imitating the joint can be repeated in the natural wood pattern every 33 cm to 200 cm.

In this embodiment, the surface covering element 1 preferably may comprise the same type of decorative pattern along the entire length of the strip, a decorative pattern that can be identical or different in terms of appearance, tint or colour. For example, in a surface covering element 1 imitating a panel of wood, the decorative wood pattern can have a colour, tint, and graining identical the entire length of the strip of the surface covering element 1. Nevertheless, the graining reproduced can also be different from one decorative module to another. However, one or both ends of the surface covering element 1 can comprise a decorative module having a length different from the other decorative modules that make the surface covering element 1, for example, a length that corresponds to a half-length of the other modules. Thus, when laying the surface covering element 1, the decorative modules of a strip are shifted in relation to the decorative modules of an adjacent strip, thereby giving the surface covered the appearance of true wood covering.

In this embodiment, the decorative pattern reproduces the aesthetic appearance of any element of natural surface covering, whether it is a strip of wood, a strip of bamboo, a marble floor tile, tiling, terra cotta, stone, granite, slate, pebbles or mosaics. Thus, the decorative modules of the surface covering element 1 reproduces the aesthetic appearance, but also the dimensions of any elements of natural floor covering. Preferably, the decorative pattern reproduces also the dimensions and the aesthetic appearance of any joints connecting the natural elements to be imitated. The joint pattern can be more or less thick or pronounced, and thus more or less discrete. The pattern can be a more or less thick line, more or less pronounced, or can be the demarcation between different structures or colours of the decorative pattern.

The polymer-based surface covering element 1 according to the invention is obtained by producing a decorated homogenous or multiple layer intermediate product, not intended to be used as surface covering, and may comprise, or not, a decorative pattern, imitating for example a natural pattern (wood, stone . . . ) and a pattern imitating a joint. The intermediate product is then cut, using appropriate means, into strips having the length and width according to the invention. The strips my then be processed to produce connection means 8.

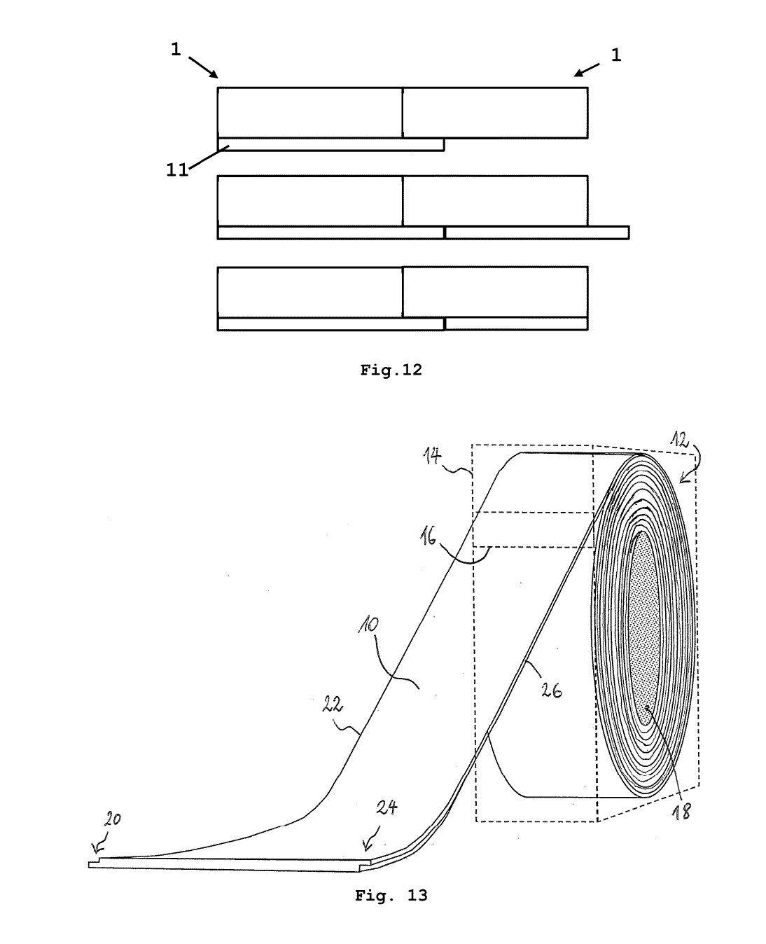

The surface covering according to the invention comprises one or more surface covering element 1 according to the invention (FIG. 11). The surface covering may also comprise one or more elements to be joined in the form of a strip as describe but without connection means (8) (FIG. 12), the surface covering elements 1 comprising connection means (8) being connected to surface covering elements 1 comprising, or not, connection means (8).

The installation of the surface covering according to the invention is very easy and do not need the use of a glue to connect a surface covering element 1 to another. A first surface covering element 1 is laid on the surface to cover, for example on a corner, and a second surface covering element 1 is connected to the first one by means of the connection means 8, said second surface covering element 1 may comprise or not complementary connection means (FIG. 12).

As illustrated in FIG. 13, the surface covering element 10 can take the form of a roll 12 e.g. packaged in a dispenser box 14. The surface covering element 10 can be to be laid out by unrolling it from the roll 12 and pulling it through an aperture 16 in the dispenser box 14. In the box, the surface covering element may be wound up on a cylindrical core 18 (e.g. made from paperboard or whatever the material of the box 14 is.) A male portion 20 of the connection means extends along the long edge 22 of the surface covering element 10. The female portion 24 of the connection means extends along the opposite long edge 26. The male and female portions 20, 24 are of complementary shapes.

The width of the roll 12, i.e. the distance between the long edges 22, 26 of the surface covering element preferably amounts to between 6 cm and 40 cm, more preferably between 10 cm and 30 cm. Its length preferably ranges from 5 m to 30 m.

The surface covering element 10 preferably comprises an adhesive on the male and/or the female connecting portion 20, 24. The adhesive may be protected by a release liner (not shown) to be taken off immediately before assembling two neighbouring surface covering elements. The surface covering element need not comprise any adhesive on its bottom surface 28.

1-17. (canceled)

18. A resilient polymer-based surface covering element comprising an upper surface, a lower surface, side edges provided between said upper surface and said lower surface, and connection means to join two or more surface covering elements, wherein said surface covering element is a strip provided as a roll to be laid out by unrolling from said roll, and said connection means comprise a male portion on one long edge of said strip and a female portion on the other long edge of said strip, said male and female portions being mutually complementary in shape; and
wherein said roll is packaged in a dispenser box with an aperture, so that the surface covering element can be laid out by unrolling it from the roll and pulling it through said aperture.

19. The resilient polymer-based surface covering element according to claim 18, wherein said male portion and/or said female portion of said connection means comprises an adhesive protected by a release liner.

20. The resilient polymer-based surface covering element according to claim 18, wherein the connection means are provided continuously along the entire length of said surface covering element.

21. The resilient polymer-based surface covering element according to claim 18, wherein the connection means are shaped to form a tongue and groove engagement.

22. The resilient polymer-based surface covering element according to claim 18, wherein the connection means are shaped to form a puzzle type of engagement.

23. The resilient polymer-based surface covering element according to claim 18, being made of PVC, polyolefin, reticulated and non-reticulated elastomer.

24. The resilient polymer-based surface covering element according to claim 18, being a multilayer covering comprising a support layer and a wear layer.

25. The resilient polymer-based surface covering element according to claim 18, wherein the width of said surface covering element is between 6 cm and 40 cm, preferably between 10 cm and 30 cm.

26. The resilient polymer-based surface covering element according to claim 18, wherein the roll is wound up on a cylindrical core in the dispenser box.

27. The resilient polymer-based surface covering element according to claim 18, wherein the length of the strip ranges from 4 m to 30 m, preferably 5 m to 30 m.

28. The resilient polymer-based surface covering element according to claim 18, wherein its bottom surface does not comprise any adhesive.

29. The resilient polymer-based surface covering element according to claim 18, which is a resilient floor covering fulfilling the recommendation of the norm ISO 10581.

30. A method for installing a resilient polymer-based surface covering comprising the steps of:
providing a surface covering element as claimed in claim 18;
laying out said surface covering element by unrolling it from said roll and pulling it through said aperture of said dispenser box.
